(19) United States
(12) Patent Application Publication
(10) Pub. No.: US 2018/0319231 A1
(43) Pub. Date: Nov. 8, 2018

(54) INFLATABLE OBJECT PRESSURE EQUALIZER

(71) Applicant: CZTC Holdings, LLC, Hallandale, FL (US)

(72) Inventor: Christopher Zimmerman, Hollywood, FL (US)

(21) Appl. No.: 15/971,209

(22) Filed: May 4, 2018

Related U.S. Application Data
(60) Provisional application No. 62/502,361, filed on May 5, 2017.

(51) Int. Cl. B60C 29/06; B60S 5/04

(52) U.S. Cl. CPC B60C 29/064; B60S 5/043

(57) ABSTRACT

A non-motor driven device for redistributing air from an inflatable object with a high pressure to an inflatable object having a lower pressure. The pressure equalizer device is configured for redistributing fluid, preferably pressurized air, between independent inflatable objects. The pressure equalizer contains a main body configured to engage and connect separate, independent inflatable objects together and to a plurality of intermediate inflatable object engaging members. The main body is further configured to allow fluid to travel therethrough. The main body may comprise a first air redistribution component, a second air redistribution component, and a third air redistribution component, in addition to a plurality of inflatable object air valve stem locking members.

### CROSS REFERENCE

In accordance with 37 C.F.R. 1.76, a claim of priority is included in an Application Data Sheet filed concurrently herewith. Accordingly, the present invention claims priority to U.S. Provisional Application No. 62/502,361, entitled, “INFLATABLE OBJECT PRESSURE EQUALIZER”, filed May 5, 2017. The contents of the above referenced application are incorporated herein by reference in their entirety.

### FIELD OF THE INVENTION

The present invention relates to a pressure equalizing device; to a non-motor driven device for pressuring/depressurizing inflatable objects; to a non-motor driven device for redistributing air from an inflatable object with a high pressure to an inflatable object having a lower pressure; and more particularly, to a non-compression tire pressure equalizing device for simultaneously inflating or deflating multiple tires without the use of an air compressor, wherein an equal pressure results within each of the multiple tires.

### BACKGROUND OF THE INVENTION

Transportation using motorized vehicles, such as automobiles, is a modern-day necessity. Use of automobiles is vital to the commercial industry, transporting commercial goods to retail stories for purchase and for providing a mechanism to get individuals into the stores. Use of automobiles is a vital aspect of the non-commercial industry, providing a mechanism for individuals to travel to work, travel to commercial establishments, like restaurants or retail stores, or to transport their children to various places, such as school or social/athletic activities. While technology is improving the safety and reliability of automobiles, inflation of tires remains a potential problem. Underinflated tires can be problematic and dangerous to a driver. One of the main problems with underinflated tires is that they can occur at the wrong times. Proper maintenance and monitoring of tire pressure can prevent such conditions. However, many automobile owners fail to properly maintain their tires. Moreover, even with proper maintenance, underinflated tires can result.

In many instances, an underinflated tire occurs at inconvenient times. In a typical scenario, the automobile owner gets stuck on the road with an underinflated tire at a location away from home or away from a place that may provide assistance. This situation results in the driver being required to fix the car on the road. In addition to being inconvenient, this situation may be dangerous, as a fix may require being exposed to possible interaction with other moving vehicles. Often times, fixing the underinflated tire requires use of a compressor. Not only is this a piece of equipment that must be left in the vehicle, most compressors require some type of maintenance, i.e. charging a battery, to maintain use of the device. For those drivers that do not maintain the power source, the compressor might not be available when required.

### SUMMARY OF THE INVENTION

The present invention provides a non-motor driven device for redistributing air from an inflatable object with a high pressure to an inflatable object having a lower pressure. The pressure equalizer device is configured for redistributing fluid, preferably pressurized air, between independent inflatable objects. The pressure equalizer contains a main body configured to engage and connect separate, independent inflatable objects together and a plurality of intermediate inflatable object engaging members. The main body is further configured to allow fluid to travel therethrough. The main body may comprise a first air redistribution component, a second air redistribution component, a third air redistribution component, and a plurality of inflatable object air valve stem locking members.

In an illustrative embodiment, the pressure equalizer configured for redistributing fluid between independent inflatable objects comprise: a main body sized and shaped to move fluid therethrough, said main body configured to engage and fluidly connect separate, independent inflatable objects together, wherein said fluid is redistributed from one or more independent inflatable objects with a high pressure to one or more independent inflatable objects having a lower pressure; and a plurality of intermediate inflatable object engaging members. The main body may comprise a first fluid redistribution component, said first fluid redistribution component comprising a first end configured to engage with a fluid valve of at least one of said independent inflatable objects, a second end configured to engage or connect with at least a portion of a second fluid distribution component or at least one of said plurality of intermediate inflatable engaging members, and a first fluid passageway therebetween; the second fluid redistribution component comprising a first end configured to engage with at least a portion of the first fluid distribution component or at least one of the plurality of intermediate inflatable engaging members, a second end configured to engage with at least a portion of a third fluid distribution component, and a second fluid passageway therebetween; the third fluid distribution component having a first end configured to engage with a fluid valve of at least one of the independent inflatable objects, a second end configured to engage with at least a portion of the second fluid distribution component or at least one of the plurality of intermediate inflatable engaging members, and a third fluid passageway therebetween.

Accordingly, it is an objective of the invention to provide a pressure equalizing device.

It is a further objective of the invention to teach a non-motor driven device for pressuring/depressurizing inflatable objects.

It is yet another objective of the invention to teach a non-motor driven device for redistributing air from an inflatable object with a high pressure to an inflatable object having a lower pressure.

It is a still further objective of the invention to teach a non-compression tire pressure equalizing device for simultaneously inflating or deflating multiple tires without the use of an air compressor, wherein an equal pressure results within each of the multiple tires.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top right isometric view of an embodiment of an inflatable object pressure equalizer device;

FIG. 2 is a top view of the inflatable object pressure equalizer device;

FIG. 3 is a bottom view of the inflatable object pressure equalizer device;

FIG. 4 is a right side view of the inflatable object pressure equalizer device;

FIG. 5 is a left side view of the inflatable object pressure equalizer device;

FIG. 6 is a front view of the inflatable object pressure equalizer device;

FIG. 7 is a rear view of the inflatable object pressure equalizer device;

FIG. 8 illustrates the inflatable object pressure equalizer device in an expanded state, engaged with and secured to all four tires of a vehicle;

FIG. 9 shows components of the main body of the pressure equalizer interconnected through a branch or t-shaped connector;

FIG. 10 illustrates an embodiment of the inflatable object pressure equalizer having components that maintain tension in the line when the pressure equalizer is in use; and

FIG. 11 is a close-up view of the components that maintain tension in the line when the pressure equalizer is in use.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention, and is not intended to limit the invention to the specific embodiments illustrated.

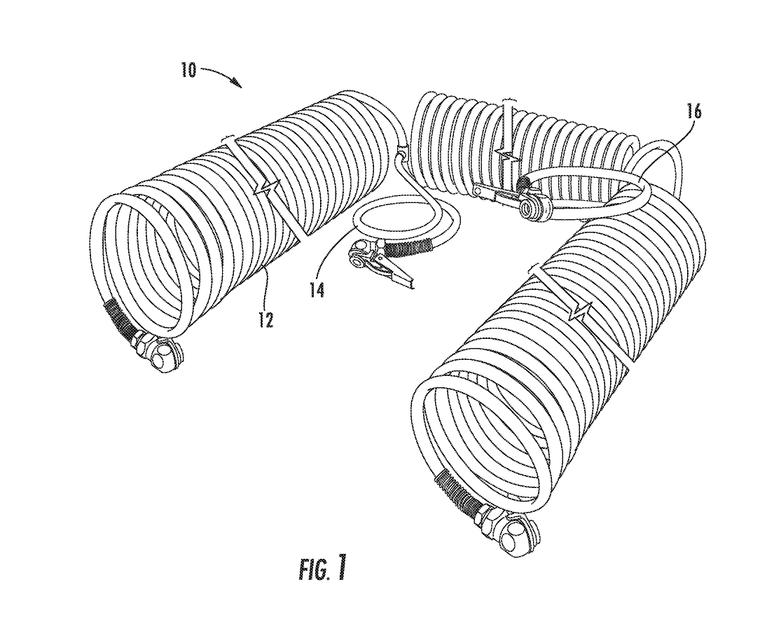

Referring to FIG. 1, a device configured for redistributing fluid, preferably pressurized air, between independent inflatable objects, referred to generally as a pressure equalizer 10, is shown. The pressure equalizer 10 contains a main body 12, which is configured to engage and connect separate, independent inflatable objects together, and a plurality of intermediate inflatable object engaging members 14 and 16. The main body 12 is further configured to allow fluid, illustrated herein as air, preferably pressurized air, to travel therethrough. The main body 12 comprises a plurality of air redistribution components: 18 (also referred to as the first air redistribution component), 20 (also referred to as the second air redistribution component), and 22 (also referred to as the third air redistribution component).

The first air redistribution component 18 comprises a fluid distribution body 24 having a first end 26 configured to engage and secure to an inflatable object and a second end 28 configured to engage with a portion of another air redistribution component, such as the second air redistribution component 20, and also one of the plurality of intermediate inflatable object engaging members 14 or 16. The first air redistribution body 18 is made of a material that allows fluid to travel therein, such as polyurethane plastic tubing. In a preferred embodiment, the first air redistribution component 18 is made of a flexible material that can be maintained in a first compact configuration and traversed to a second extended, generally linear orientation, by applying a stretching or pulling force. While the first air redistribution component 18 has been described as being made of polyurethane plastic tubing, such material is illustrative only. Other materials, such as nylon tubing, PTFE (polytetrafluoroethylene) tubing, stainless steel pneumatic air hose, or other metals known to one of skill in the art may be used.

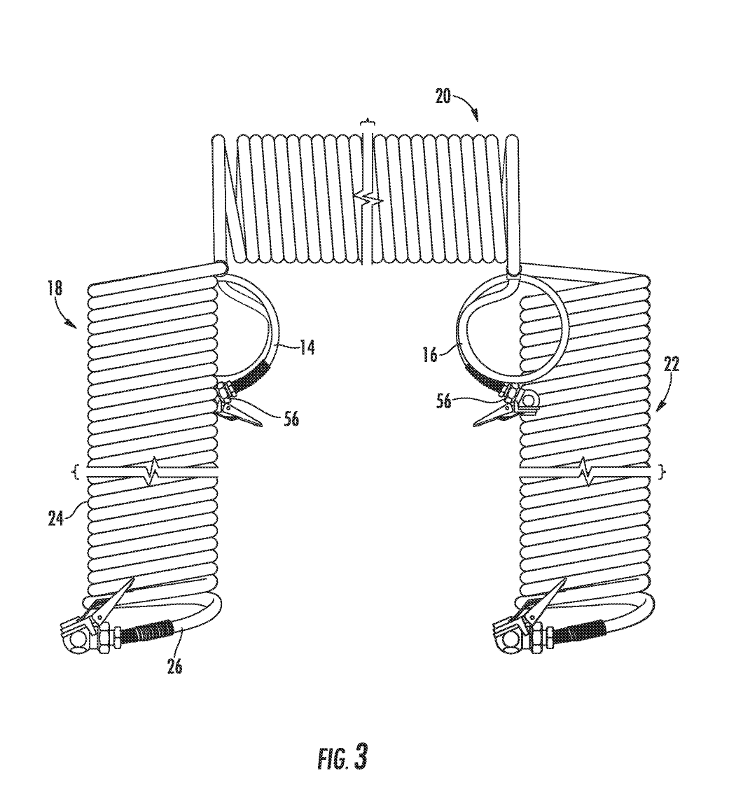

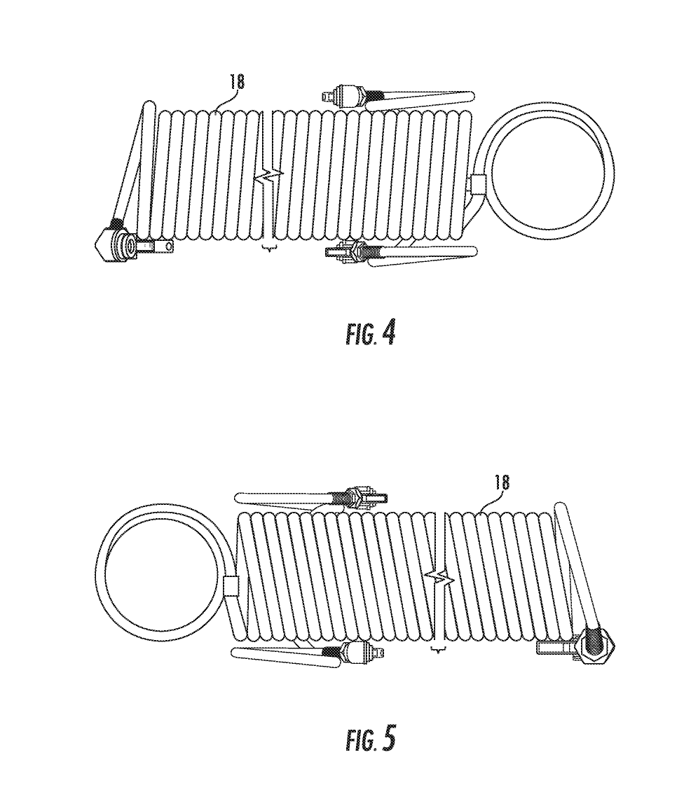

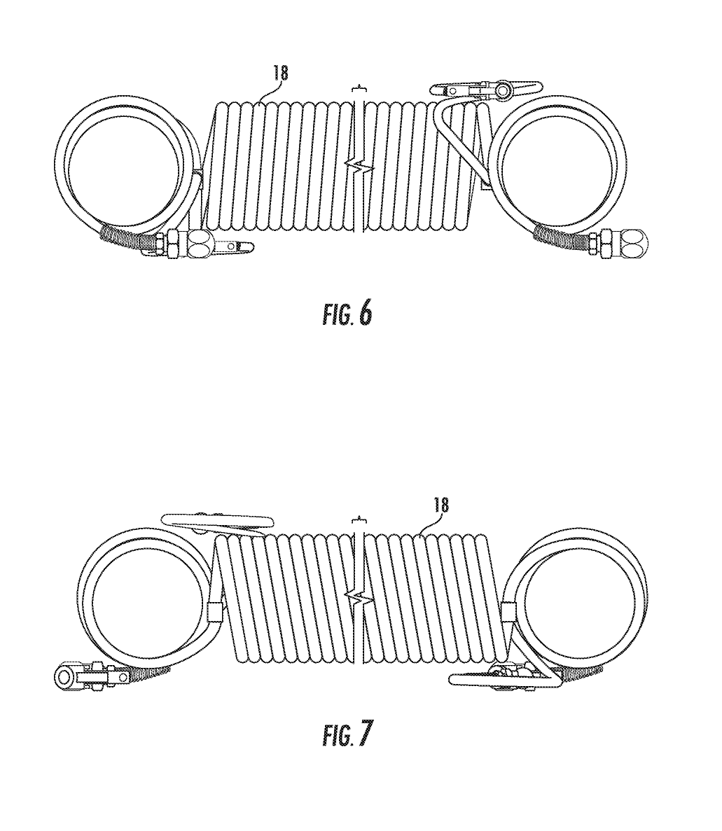

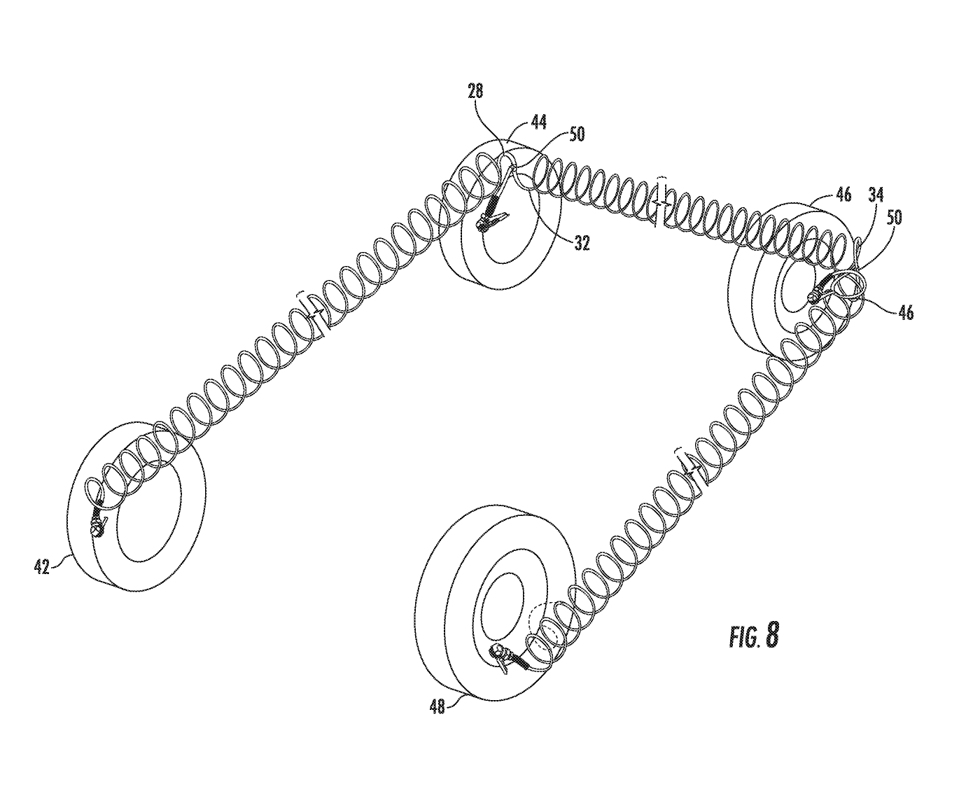

As illustrated in FIGS. 1-7, the first air redistribution component 18 is formed as a coiled or helical shape, with the first end 26 and the second end 28 having a non-helical orientation and expanding out from the helical shape. The second air redistribution component 20 and the third air redistribution component 22 are similar. The second air redistribution component 20 includes a coiled or helical fluid distribution body 30 having a first end 32 and a second end 34. The first end 32 and the second end 34 each have a non-helical orientation and expand out from the helical shaped second air redistribution component 20. The third air redistribution component 22 includes a coiled or helical fluid distribution body 36 having a first end 38 and a second end 40. The first end 38 and the second end 40 each have a non-helical orientation and expand out from the helical shaped third air redistribution component 22.

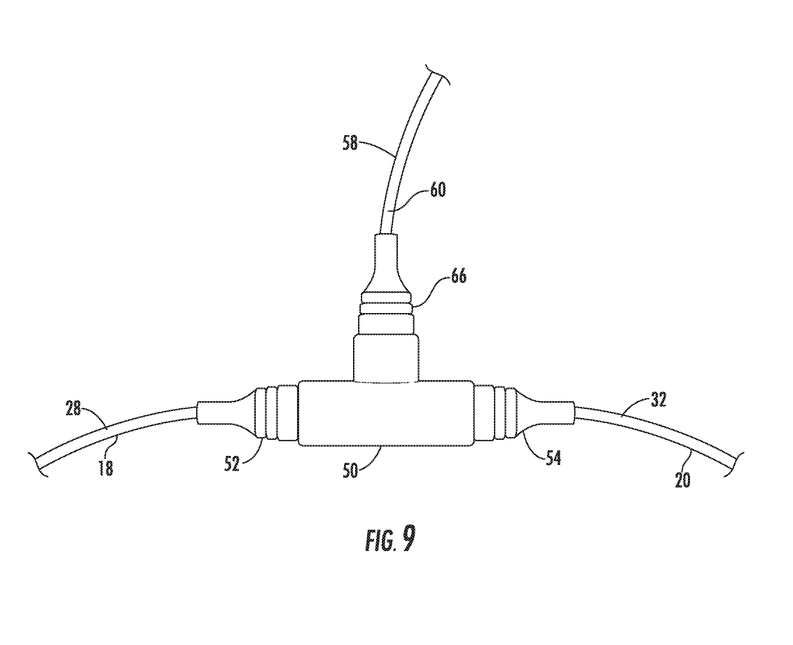

The first air redistribution component 18, the second air redistribution component 20, and the third air redistribution component 22 are interconnected to allow the pressure equalizer 10 to be engaged and secured to multiple, independent inflatable objects at one time. FIG. 8 illustrates the pressure equalizer 10 in which first air redistribution component 18, second air redistribution component 20, and third air redistribution component 22 are in an expanded state and engaged and secured to four (4) independent inflatable objects, illustrated herein as tires 42, 44, 46, and 48 associated with an automobile. The body of the automobile is removed from the figure to more clearly illustrate how the pressure equalizer 10 can be connected to the four tires at one time.

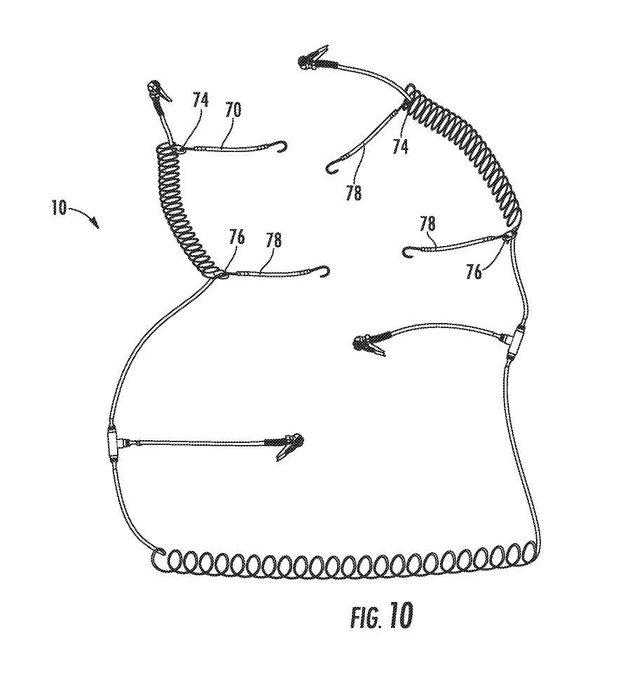

The first air redistribution component 18 can be connected to the second air redistribution component 20 through the use of a branch or t-shaped connector 50, see FIG. 9. The second end 28 of the first air redistribution component 18 contains a quick connect pneumatic fitting 52 secured to one branch of the branch connector 50. The first end 32 of the second air redistribution component 20 also contains a quick connect pneumatic fitting 54 secured to one branch of the branch connector 50. The second air redistribution component 20 is connected to the third air redistribution component 22 using a branch or t-shaped connector 50, thereby connecting the second air redistribution component second end 34 to the third air redistribution component second end 40.

The first air redistribution component first end 26 contains an inflatable object air valve stem locking member, illustrated herein as a lockable clip-on ball chuck 56. Other pneumatic locking chucks, such as a ball foot air chuck, a locking Schrader chuck, or a closed clip-on air chuck may be used as well. The third air redistribution component first end 38 also contains a clip-on ball chuck 56.

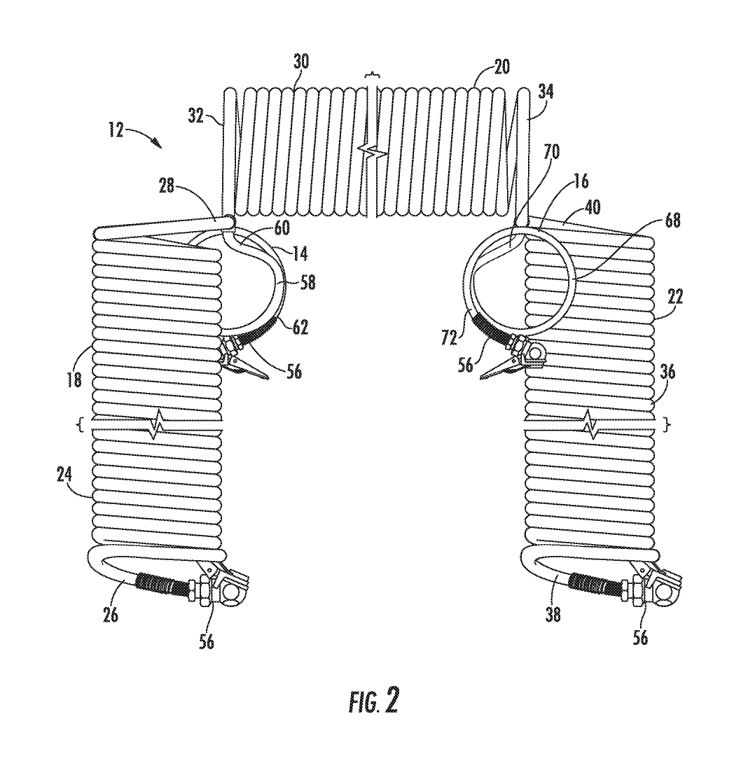

The intermediate inflatable object engaging members 14 or 16 are designed to provide additional members for attachment to independent inflatable objects. The intermediate inflatable object engaging member 14 comprises an elongated body 58 with two opposing ends, first end 60 and second end 62. The first end 60 is connected to the branch or t-shaped connector 50 using a quick connect pneumatic fitting 66, see FIG. 9. The second end 62 contains a clip-on ball chuck 56, see FIG. 2. The intermediate inflatable object engaging member 16 comprises an elongated body 68 with two opposing ends, first end 70 and second end 72. The first end 70 is connected to the branch or t-shaped connector 50 using a quick connect pneumatic fitting 66. The second end 72 contains a clip-on ball chuck 56.

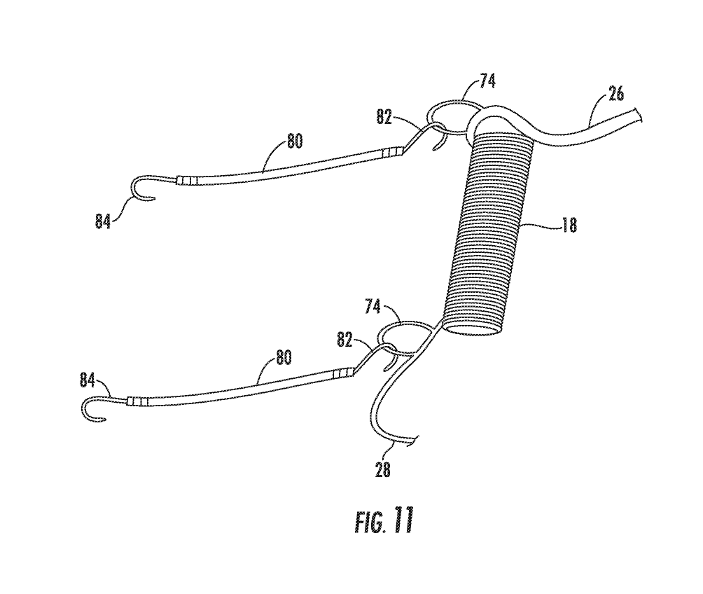

Referring to FIG. 10, the pressure equalizer 10 is shown with additional features. One or more of the plurality of air redistribution components may contain a component that maintains tension in the line when the pressure equalizer 10 is in use, i.e. attached to tires 42, 44, 46, and 48, and redistributing air. Preferably, the first air redistribution component 18 and the third air redistribution component 22 contain two rings, 74 and 76, which are designed to receive and hold an elastic member 78. FIG. 11 provides a close up view of the rings, 74 and 76, associated with the first air redistribution component 18. The elastic member 78 is illustrated as a bungee cord 80 (elastic cord with one or more strands forming a core and covered with a woven or polypropylene sheath) having J-shaped hooks 82 and 84. Alternative hook ends may include carabiner hooks. Rings 74 and 76 may be integrally formed with a portion of the fluid distribution body 24 (or 36) or may be formed separately and attached thereto.

To aid in properly attaching to the tires, one or more components may be designed to rotate. As an illustrative example, one or more of the inflatable object air valve stem locking member, i.e. the lockable clip-on ball chuck 56, or the quick connectors, may be designed to be orbital. In this manner, a user may be able to secure one or more components to the inflatable objects, i.e. the tires 42, 44, 46, and 48, without the requirement of such objects being in the right orientation. If one or more portions are not aligned correctly, the user may simply rotate them to the correct orientation.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A pressure equalizer configured for redistributing fluid between independent inflatable objects comprising:
a main body sized and shaped to move fluid therethrough, said main body configured to engage and fluidly connect separate, independent inflatable objects together, wherein said fluid is redistributed from one or more independent inflatable objects with a high pressure to one or more independent inflatable objects having a lower pressure; and
a plurality of intermediate inflatable object engaging members.

2. The pressure equalizer configured for redistributing fluid between independent inflatable objects according to claim 1 wherein said main body comprises:
a first fluid redistribution component, said first fluid redistribution component comprising a first end configured to engage with a fluid valve of at least one of said independent inflatable objects, a second end configured to engage or connect with at least a portion of a second fluid distribution component or at least one of said plurality of intermediate inflatable engaging members, and a first fluid passageway therebetween;
said second fluid redistribution component comprising a first end configured to engage with at least a portion of said first fluid distribution component or at least one of said plurality of intermediate inflatable engaging members, a second end configured to engage with at least a portion of a third fluid distribution component, and a second fluid passageway therebetween;
said third fluid distribution component having a first end configured to engage with a fluid valve of at least one of said independent inflatable objects, a second end configured to engage with at least a portion of said second fluid distribution component or at least one of said plurality of intermediate inflatable engaging members, and a third fluid passageway therebetween.

3. The pressure equalizer configured for redistributing fluid between independent inflatable objects according to claim 1, wherein said fluid is pressurized air.

4. The pressure equalizer configured for redistributing fluid between independent inflatable objects according to claim 5, wherein said first fluid distribution body, said second fluid distribution body, or said third fluid distribution body are independently expandable.

5. The pressure equalizer configured for redistributing fluid between independent inflatable objects according to claim 2, wherein said first fluid distribution body, said second fluid distribution body, or said third fluid distribution body are coiled or helically shaped.

6. The pressure equalizer configured for redistributing fluid between independent inflatable objects according to claim 2, wherein said first fluid distribution body is connected to said second fluid distribution body by a branch or t-shape connector.

7. The pressure equalizer configured for redistributing fluid between independent inflatable objects according to claim 2, wherein said first fluid distribution body and said third fluid distribution body each comprise an inflatable object air valve stem locking member.

8. The pressure equalizer configured for redistributing fluid between independent inflatable objects according to claim 7, wherein said inflatable object air valve stem locking member is a lockable clip-on ball chuck or lock on air chuck.

9. The pressure equalizer configured for redistributing fluid between independent inflatable objects according to claim 2, wherein each of said plurality of intermediate inflatable object engaging members comprise an elongated body having a first end and an opposing second end, said first end configured to connect to at least one portion of said first fluid distribution body, said second fluid distribution body, or said third fluid distribution body, and said second end having an inflatable object air valve stem locking member configured to secure to at least one of said independent inflatable objects.

10. The pressure equalizer configured for redistributing fluid between independent inflatable objects according to claim 9, wherein said inflatable object air valve stem locking member is a lockable clip-on ball chuck or lock on air chuck.

11. The pressure equalizer configured for redistributing fluid between independent inflatable objects according to claim 1, wherein at least one portion of said main body is rotatable.

12. The pressure equalizer configured for redistributing fluid between independent inflatable objects according to claim 7, wherein one or more of the inflatable object air valve stem locking members are rotatable or orbital.

13. The pressure equalizer configured for redistributing fluid between independent inflatable objects according to claim 2, wherein said first fluid distribution body, said second fluid distribution body, or said third fluid distribution body comprises a ring sized and shaped to receive and hold an elastic member.

14. The pressure equalizer configured for redistributing fluid between independent inflatable objects according to claim 2, further including an elastic member.

15. The pressure equalizer configured for redistributing fluid between independent inflatable objects according to claim 14, wherein said elastic member is a bungee cord.

16. The pressure equalizer configured for redistributing fluid between independent inflatable objects according to claim 15, wherein said bungee cord comprises a hook at one end sized and shaped to connect to an object.
